(19) United States
(12) Patent Application Publication
(10) Pub. No.: US 2017/0028555 A1
(43) Pub. Date: Feb. 2, 2017

(54) ROBOT CONTROL APPARATUS FOR COMPENSATING FOR ELASTIC DEFORMATION OF SUPPORT BODY

(71) Applicant: FANUC CORPORATION, Minamitsuru-gun (JP)

(72) Inventor: Kyouhei Kokubo, Minamitsuru-gun (JP)

(73) Assignee: FANUC CORPORATION, Minamitsuru-gun (JP)

(21) Appl. No.: 15/216,833

(22) Filed: Jul. 22, 2016

(30) Foreign Application Priority Data
Jul. 27, 2015 (JP) 2015-147957

(51) Int. Cl. B25J 9/16

(52) U.S. Cl. CPC B25J 9/1638; B25J 9/1607; G05B 2219/39176

(57) ABSTRACT

A robot control apparatus controls a motor for driving a robot fixedly installed on a support body. The robot control apparatus is provided with a deflection estimating unit for estimating, when the robot is assumed to reach a target position and posture, a deflection arising in the support body due to the influence of gravity acting on the robot, a movement amount calculating unit for calculating the amount of movement of the motor which causes the robot to reach the target position and posture, based on the deflection of the support body, which is estimated by the deflection estimating unit, and a drive unit for driving the motor based on the amount of movement calculated by the movement amount calculating unit.

### BACKGROUND OF THE INVENTION

1. Technical Field

The present invention relates to a robot control apparatus.

2. Description of the Related Art

Joints and links of a robot are elastically deformed due to gravity acting on the robot and a tool attached to the tip end of the robot. The deformation of components of a robot reduces the accuracy of positioning of the robot. Thus, a robot control method for modeling components of a robot, to compensate for the amount of deformation of the components, has been adopted.

For example, Japanese Unexamined Patent Publication (Kokai) No. 2002-307344 discloses a technology for correcting deflection of joints and links of a robot, to perform a more accurate control operation for an actuator of each joint. Japanese Unexamined Patent Publication (Kokai) No. 2010-058256 discloses a technology for adjusting the position of an arm, to remove a position gap caused by, for example, deflection of the arm. Japanese Unexamined Patent Publication (Kokai) No. 2011-125956 discloses a technology for identifying the spring constants around the x-axis, y-axis, and z-axis in respective joints of an arm of a multi-jointed robot.

Existing technologies are used to correct deflections of joints or links of a robot. However, in particular a large robot including a robot having a weight of 500 kg or more, a support body including an iron plate or an iron pedestal, on which the robot is installed, may be elastically deformed. This reduces the accuracy of positioning of the robot.

### SUMMARY OF INVENTION

A robot control apparatus which can improve the accuracy of positioning of a robot has been required.

According to a first aspect of the present invention, a robot control apparatus for controlling at least one actuator for moving a plurality of links which constitute a robot fixedly installed on a support body is provided. The robot control apparatus includes a deflection estimating unit for estimating, when a tip end of the robot is assumed to reach a target position and posture, a deflection arising in the support body due to the influence of gravity acting on the robot, a movement amount calculating unit for calculating the amount of movement of the at least one actuator which causes the tip end of the robot to reach the target position and posture, based on the deflection of the support body, which is estimated by the deflection estimating unit, and a drive unit for driving the at least one actuator based on the amount of movement calculated by the movement amount calculating unit.

According to a second aspect of the present invention, in the robot control apparatus according to the first aspect of the invention, the deflection estimating unit is configured to estimate a deflection of the support body, after additionally taking the influence of acceleration of the robot into consideration.

According to a third aspect of the present invention, the robot control apparatus according to the first aspect of the invention further includes a storage unit for storing, when the support body is modeled as a rotational spring, the spring constant of the rotational spring and the position of the center of rotation of the rotational spring, and a moment calculating unit for calculating the magnitude and direction of a moment acting on the support body under the influence of gravity acting on the robot. The deflection estimating unit is configured to estimate the deflection of the support body based on the magnitude and direction of the moment calculated by the moment calculating unit, and the spring constant and the position of the center of rotation, which are stored in the storage unit.

According to a fourth aspect of the present invention, in the robot control apparatus according to the third aspect of the invention, the moment calculating unit is configured to calculate the magnitude and direction of the moment, after additionally taking the influence of acceleration of the robot into consideration.

These and other objects, features and advantages of the present invention will become more apparent in light of the detailed description of exemplary embodiments thereof as illustrated by the drawings.

### BRIEF DESCRIPTION OF DRAWINGS

FIG. 1 is a view showing a robot system having a robot and a robot control apparatus.

FIG. 2 is a view showing the drive mechanism of the robot of FIG. 1.

FIG. 3 is a block diagram of a robot control apparatus according to an embodiment.

FIG. 4 is a functional block diagram of a robot control apparatus according to an embodiment.

FIG. 5 is a flowchart of processes performed by a robot control apparatus according to an embodiment.

FIG. 6 is a view showing a support body on which a robot is installed.

FIG. 7 is a view showing another example of the configuration of a robot.

FIG. 8 is a view showing the drive mechanism of the robot of FIG. 7.

### DETAILED DESCRIPTION

Embodiments of the present invention will be described below with reference to the accompanying drawings. To facilitate understanding of the present invention, the reduction scales of components in the illustrated embodiments are suitably changed. Further, the same or corresponding components are designated with the same reference numerals.

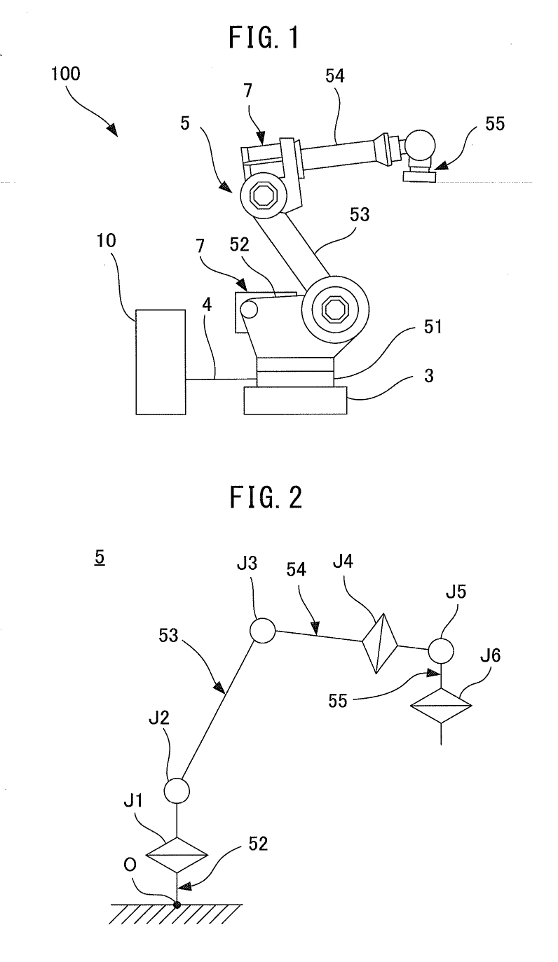

With reference to FIGS. 1 to 4, the configuration of a robot control apparatus according to an embodiment of the present invention will be described below. FIG. 1 shows a robot system 100 having a robot 5 and a robot control apparatus 10 for controlling the robot 5.

The robot 5 is a 6-axis vertical articulated robot having a base 51, a turning body 52, a lower arm 53, an upper arm 54, and a wrist part 55. The robot 5 has joints J1 to J6 (see FIG. 2). Each of the joints J1 to J6 is driven by the corresponding one of motors 7 (Only some of the motors are shown in the drawing).

Regarding links composed of the lower arm 53, the upper arm 54, etc., the links are configured to move in accordance with the movement of a joint provided between the adjacent links. This enables the robot 5 to position an end effector (not shown) attached to the wrist part 55 at a desired posture and at a desired position. Such configuration and mechanism of the robot 5 are well known, and accordingly, will not be described in detail in this specification.

The base 51 of the robot 5 is secured to a support body 3. The support body 3 is a metal member having a form of, for example, a plate or a pedestal. The support body 3 is used as a member on which the robot 5 is fixedly disposed at a predetermined position.

The robot 5 is connected to the robot control apparatus 10 via a known communication means, for example, a communication cable 4. The robot control apparatus 10 is a digital computer having a known hardware configuration including a main CPU 11, a memory 12, and various kinds of interfaces (not shown).

The memory 12 has a ROM, a RAM, a non-volatile memory, etc. The ROM stores a system program for controlling the basic action of the robot control apparatus 10. The RAM temporarily stores a result of calculation of the main CPU 11. The RAM is also used to store values counted by a counter that will be described later.

The non-volatile memory stores, for example, action programs for controlling the robot 5 and parameters necessary to produce commands for the robot 5 based on the action program. The non-volatile memory also stores data regarding the mass and the position of the center of gravity of the links of the robot 5 and the tool attached to the tip portion. Further, the non-volatile memory stores information regarding the spring constant of a rotational spring used to calculate the deflection of the support body 3, and the position of the center of rotation of the rotational spring, which will be described later.

The robot control apparatus 10 is connected to external devices, such as a display, an input device, such as a mouse or a keyboard, and an operation teaching board, via various kinds of interfaces, although the external devices are not illustrated.

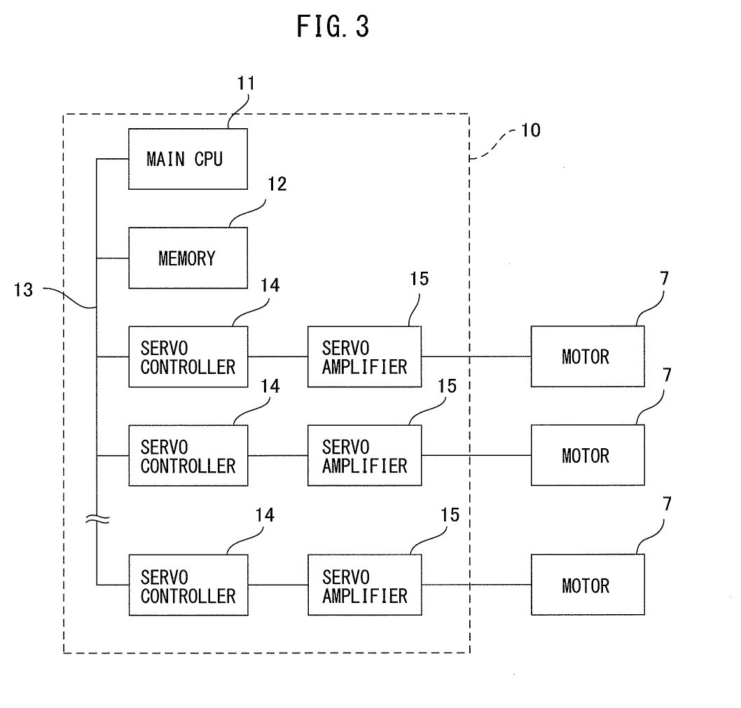

With reference to FIG. 3, the main CPU 11 and the memory 12 of the robot control apparatus 10 are connected to servo controllers 14 and servo amplifiers 15 provided for the corresponding joints J1 to J6, via a bus cable 13.

Each servo controller 14 outputs a voltage command or a current command to the corresponding servo amplifier 15. The voltage command or the current command are made based on the amount of deviation between a movement command made in accordance with the action program stored in the memory 12 and feedback signals output from pulse coders provided for the corresponding joints J1 to J6.

The servo amplifiers 15 supply current to the corresponding motors 7 in accordance with voltage commands or current commands output from the servo controllers 14. The motors 7 operate in accordance with the current supplied from the servo amplifiers 15, and drive the joints J1 to J6 of the robot 5 via reduction gears.

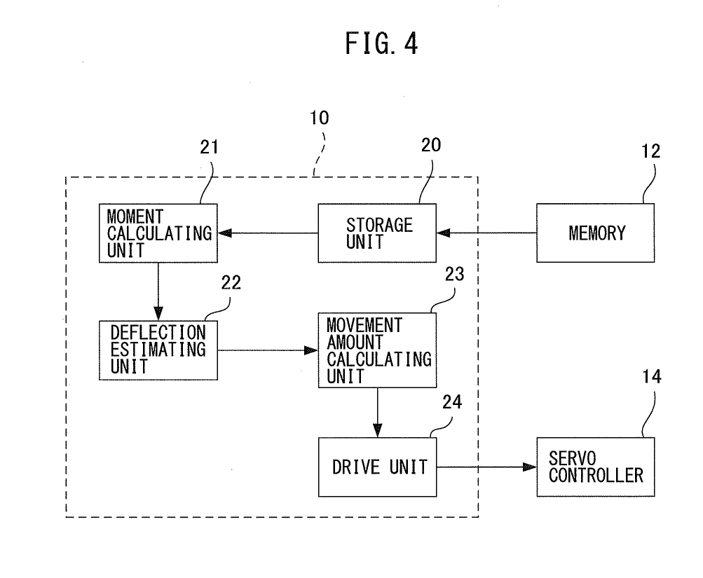

FIG. 4 is a functional block diagram of the robot control apparatus 10 according to an embodiment. As shown in FIG. 4, the robot control apparatus 10 has a storage unit 20, a moment calculating unit 21, a deflection estimating unit 22, a movement amount calculating unit 23, and a drive unit 24.

In the storage unit 20, the non-volatile memory of the memory 12 stores, when the support body 3 is modeled as a rotational spring, the spring constant of the rotational spring and the position of the center of rotation of the rotational spring.

The moment calculating unit 21 calculates a moment acting on the support body 3 under the influence of gravity acting on the robot 5 when the robot 5 reaches a target position or posture. The moment obtained by the moment calculating unit 21 has magnitude and direction of action. In an embodiment, the moment calculating unit 21 may be configured to calculate the magnitude and direction of the moment acting on the support body 3 after additionally taking the force of inertia caused by the acceleration of the robot 5 into consideration.

The deflection estimating unit 22 estimates, on the assumption that the robot 5 reaches a target position or posture, a deflection arising in the support body 3 under the influence of gravity acting on the robot 5. In an embodiment, the deflection estimating unit 22 may be configured to estimate the deflection of the support body 3 based on the magnitude and direction of the moment calculated by the moment calculating unit 21, and the spring constant and the position of the center of rotation, which are stored in the storage unit 20. Further, in an embodiment, the deflection estimating unit 22 may be configured to estimate the deflection of the support body 3 after additionally taking the force of inertia caused by the acceleration of the robot 5 into consideration.

The movement amount calculating unit 23 calculates the amount of movement of each motor 7 based on the deflection of the support body 3 estimated by the deflection estimating unit 22, to cause the tip end of the robot 3 to reach a target position and posture. The amount of movement obtained by the movement amount calculating unit 23 corresponds to the amount of movement of each motor 7, which is necessary to compensate for the deflection of the support body 3.

The drive unit 24 drives each motor 7 based on the amount of movement calculated by the movement amount calculating unit 23.

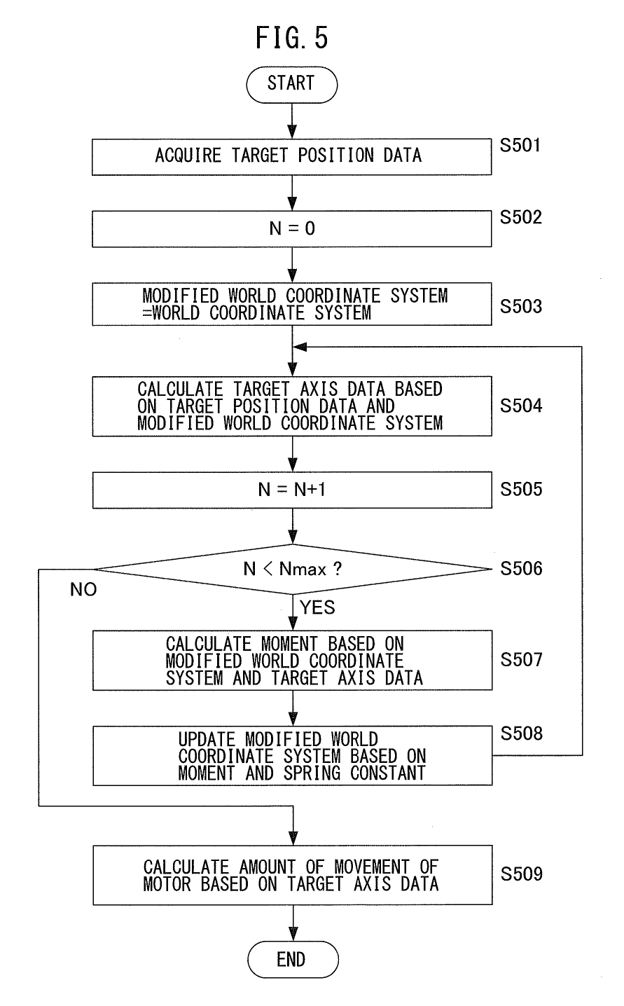

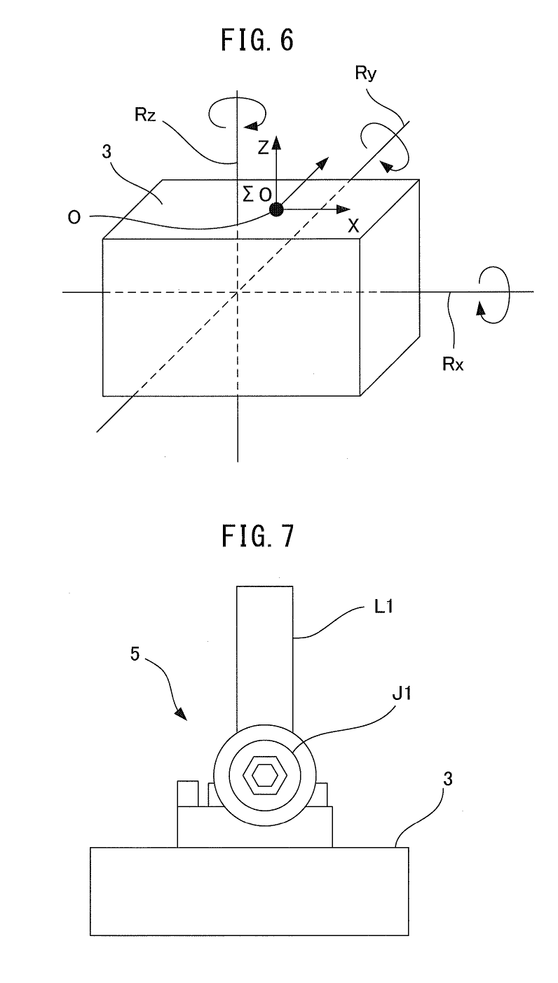

With reference to the flowchart shown in FIG. 5, the operations performed by the robot control apparatus 10 according to an embodiment will be described below. In the following description, a “world coordinate system Σ0” is a coordinate system in which a certain point in the support body 3 which is not deflected is set as an origin O, and the direction in which the gravitational force acts is set as the negative direction of the z-axis, as shown in FIG. 6. The origin O is a point representative of the support body 3. The origin O may be set at, for example, the center of the area in which the robot 3 is installed.

A “modified world coordinate system Σ1” is a coordinate system obtained by modifying the “world coordinate system Σ0” in accordance with the deflection of the support body 3. Namely, in the modified world coordinate system, the position and posture of the support body 3 vary depending on the magnitude and direction of deflection of the support body 3.

With reference to FIG. 5, in step S501, the main CPU 11 acquires target position data for the robot 5 in accordance with the action program of the robot 5 stored in the memory 12. The “target position data” include at least one of the target position and posture, the target velocity vector, the target angular velocity vector, and the target angular acceleration vector of the robot 5 at the time. These target position data are represented as coordinate values in the respective axes in the world coordinate system Σ0. “Target axis data” that will be described later are data defined depending on the “target position data”, and include at least one of the target position, the target angular velocity and the target angular acceleration of the respective joints J1 to J6 at the time when the robot 5 reaches a target position and posture.

According to the present embodiment, the target axis data corresponding to the target position data are repeatedly calculated a predetermined number of times together with the modified world coordinate system Σ1, to obtain a convergent solution. In step S502, the count value of a counter for counting the number of repeated calculation is set at zero. The count value N of the counter is stored in the RAM of the memory 12. In step S503, the modified world coordinate system Σ1 is assumed to be coincident with the world coordinate system Σ0 in a default setting.

Subsequently, in step S504, the target axis data are calculated based on the target position data and the modified world coordinate system Σ1. If the deflection of the support body 3 is not taken into consideration, the target axis data are calculated by the well-known inverse kinematics transformation of a robot. The inverse transformation can be calculated by a system program stored in the ROM of the memory 12. According to the present embodiment, the target axis data are calculated using the modified world coordinate system Σ1 in place of the world coordinate system Σ0. When the inverse transformation is calculated, the velocity, angular velocity, acceleration, and angular acceleration of the support body 3 are extremely small in comparison with those of the robot 5, and accordingly, can approximate to zero. Namely, values obtained without taking the deflection of the support body 3 into consideration can be directly used as the target velocity and the target acceleration, which constitute the target axis data.

In step S505, the count value N of the counter is increased by only “1”. In step S506, whether the count value N of the counter is smaller than a repeated number Nmax is determined. If a positive result is obtained in the determination of step S506, the operation is shifted to step S507, and a moment M acting on the support body 3 of the robot 5 is calculated based on the modified world coordinate system Σ1 and the target axis data.

The moment M is obtained in accordance with well-known Newton-Euler equations. The moment M is expressed by Equation (1) below, in the world coordinate system Σ0.

$$M = [ \begin{matrix}{m}_{x} \\ {m}_{y} \\ {m}_{z}\end{matrix} ] \qquad Equation ( 1 )$$

When a plane of the support body 3, on which the robot 5 is installed, is assumed to be a rotational spring, a rotation amount D generated by the action of the moment M is expressed by Equation (2) below.

$$D = [ \begin{matrix}{d}_{x} \\ {d}_{y} \\ {d}_{z}\end{matrix} ] = [ \begin{matrix}{r}_{xx} & {r}_{yx} & {r}_{zx} \\ {r}_{xy} & {r}_{yy} & {r}_{zy} \\ {r}_{xz} & {r}_{yz} & {r}_{zz}\end{matrix} ] [ \begin{matrix}{m}_{x} \\ {m}_{y} \\ {m}_{z}\end{matrix} ] \qquad Equation ( 2 )$$

In this equation, “dₓ” represents the amount of rotation of the rotational spring around a rotational axis Rx parallel to the X-axis of the world coordinate system Σ0 (see FIG. 6). “d_{y}” represents the amount of rotation of the rotational spring around a rotational axis Ry parallel to the Y-axis of the world coordinate system Σ0. “d_{z}” represents the amount of rotation of the rotational spring around a rotational axis Rz parallel to the Z-axis of the world coordinate system Σ0.

“rₓₓ”, “r_{xy}”, “r_{xz}”, “r_{yx}”, “r_{yy}”, “r_{yz}”, “r_{zx}”, “r_{zy}”, and “r_{zz}” represent spring constant values obtained when the support body 3 is modeled as a rotational spring. The spring constant represents the relationship between the moment M and the rotation amount D, which act on the support body 3. Namely, the rotation amount D obtained by Equation (2) represents the magnitude and direction of deflection of the support body 3, in the form of the amount of rotations of the support body 3 around the rotational axes Rx, Ry, and Rz which are centers of rotations of the rotational spring

An intersection F of the rotational axis Rx and a Y-Z plane in the world coordinate system Σ0 is expressed by Equation (3) below.

$$F = [ \begin{matrix}0 \\ {f}_{y} \\ {f}_{z}\end{matrix} ] \qquad Equation ( 3 )$$

An intersection H of the rotational axis Ry and a X-Z plane in the world coordinate system Σ0 is expressed by Equation (4) below.

$$H = [ \begin{matrix}{h}_{x} \\ 0 \\ {h}_{z}\end{matrix} ] \qquad Equation ( 4 )$$

An intersection J of the rotational axis Rz and a X-Y plane in the world coordinate system Σ0 is expressed by Equation (5) below. The position of the rotational axes Rx, Ry, and Rz in the world coordinate system Σ0 is stored in the non-volatile memory of the memory 2. Thus, the coordinate values of the intersections F, H, and J are calculated based on the information stored in the memory 2.

$$J = [ \begin{matrix}{j}_{x} \\ {j}_{y} \\ 0\end{matrix} ] \qquad Equation ( 5 )$$

In step S508, the modified world coordinate system Σ1 is updated based on the moment M and the spring constant. When the dₓ, d_{y}, and d_{z} are expressed in “radians”, the coordinate transformation matrix for transforming the world coordinate system Σ0 to the modified world coordinate system Σ1 is expressed by Equation (6) below.

T(u,v,w)Rz(d_{z})Ry(d_{y})Rx(dₓ) Equation (6)

Note that Rz (d_{z}), Ry (d_{y}), Rx (dₓ), T (u, v, w), u, v, and w are expressed by Equations (7) to (13) below.

$$\begin{matrix} {R}_{z} ( {d}_{z} ) = [ \begin{matrix}cos ( {d}_{z} ) & - sin ( {d}_{z} ) & 0 & 0 \\ sin ( {d}_{z} ) & cos ( {d}_{z} ) & 0 & 0 \\ 0 & 0 & 1 & 0 \\ 0 & 0 & 0 & 1\end{matrix} ] & Equation ( 7 ) \\ {R}_{y} ( {d}_{y} ) = [ \begin{matrix}cos ( {d}_{y} ) & 0 & sin ( {d}_{y} ) & 0 \\ 0 & 1 & 0 & 0 \\ - sin ( {d}_{y} ) & 0 & cos ( {d}_{y} ) & 0 \\ 0 & 0 & 0 & 1\end{matrix} ] & Equation ( 8 ) \\ {R}_{x} ( {d}_{x} ) = [ \begin{matrix}1 & 0 & 0 & 0 \\ 0 & cos ( {d}_{x} ) & - sin ( {d}_{x} ) & 0 \\ 0 & sin ( {d}_{x} ) & cos ( {d}_{x} ) & 0 \\ 0 & 0 & 0 & 1\end{matrix} ] & Equation ( 9 ) \\ T ( u , v , w ) = [ \begin{matrix}1 & 0 & 0 & u \\ 0 & 1 & 0 & v \\ 0 & 0 & 1 & w \\ 0 & 0 & 0 & 1\end{matrix} ] & Equation ( 10 ) \\ u = {j}_{x} ( 1 - cos ( {d}_{z} ) ) + {j}_{y} sin ( {d}_{z} ) - {h}_{z} sin ( {d}_{y} ) + {h}_{x} ( 1 - cos ( {d}_{y} ) ) & Equation ( 11 ) \\ v = {f}_{y} ( 1 - cos ( {d}_{x} ) ) + {f}_{z} sin ( {d}_{x} ) - {j}_{x} sin ( {d}_{z} ) + {j}_{y} ( 1 - cos ( {d}_{z} ) ) & Equation ( 12 ) \\ w = {h}_{z} ( 1 - cos ( {d}_{y} ) ) + {h}_{x} sin ( {d}_{y} ) - {f}_{y} sin ( {d}_{x} ) + {f}_{z} ( 1 - cos ( {d}_{x} ) ) & Equation ( 13 )\end{matrix}$$

When the operation in step S508 has been completed, the operation is returned to step S504, and the target axis data are recalculated using the modified world coordinate system Σ1.

In contrast, when a negative result is obtained in the determination of step S506, i.e., when the count value N of the counter reaches Nmax, the operation is shifted to step S509. In step S509, the amount of movement of the motors 7 is calculated based on the target axis data calculated in the last step S504.

According to the present embodiment, movement commands for the motors 7 are corrected to compensate for the elastic deformation of the support body 3. This would accurately position the robot 5 if the support body 3 is elastically deformed due to the movement of the robot 5. In some cases, the accuracy of positioning is required even at an interpolation point in the path along which the robot 5 moves toward the target position and posture. In such a case, application of the aforementioned operations to the robot 5 at the interpolation point can realize an accurate positioning operation for the robot 5 in motion.

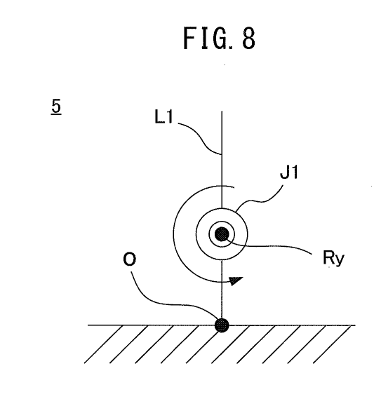

Another embodiment will now be described below. The robot control apparatus 10 according to the present embodiment is used to control the robot 5 having a single joint. FIGS. 7 and 8 show an example of the configuration of the robot 5 according to the present embodiment. The robot 5 has a joint J1 and a link L1 to be rotated by the joint J1. A point “O” shown in FIG. 8 represents the origin of the world coordinate system Σ0.

In the following description, the robot 5 is assumed to be stationary at a target position and posture. Namely, when the robot 5 is at the target position and posture, the velocity, acceleration, angular velocity and angular acceleration thereof are zero. The moment M acting on the support body 3 and the modified world coordinate system Σ1 can be obtained in a manner similar to the first embodiment described with reference to FIG. 5.

Further, assuming that the Y-axis of the world coordinate system Σ0 is coincide with the rotational axis Ry of the joint J1, the moment M is expressed by Equation (14) below.

M=gmP×G Equation (14)

In this equation, “g” represents acceleration of gravity, “m” represents the mass of the link L1, and “P” represents a vector representing the position of the center of gravity of the link L1 in the world coordinate system Σ0. “G” represents a unit vector in the direction of gravitational force, and is expressed by Equation (15).

$$G = [ \begin{matrix}0 \\ 0 \\ - 1\end{matrix} ] \qquad Equation ( 15 )$$

The vector P at the position of the center of gravity in the modified world coordinate system Σ1 is expressed by Equation (16). “θ” represents an angle of rotation of the joint J1. “L” represents a distance between the rotational axis Ry of the joint J1 and the center of gravity of the link L1.

$$P = [ \begin{matrix}L sin θ \\ 0 \\ L cos θ\end{matrix} ] \qquad Equation ( 16 )$$

Assuming that there are only a rotation around the Y-axis and a parallel shift in the X-Z plane, the Y-component of the vector P at the position of the center of gravity in the modified world coordinate system Σ1 is zero. In such a case, when the moment M is obtained using P expressed by Equation (16), the X-axis component and the Z-axis component are zero as expressed by Equation (17).

$$M = [ \begin{matrix}0 \\ gmL sin θ \\ 0\end{matrix} ] \qquad Equation ( 17 )$$

When the support body 3 is modeled as a rotational spring, the rotation amount D of the support body 3, which corresponds to the Y-axis component m_{y} of the moment M, is expressed by Equation (18).

D=rm_{y} Equation (18)

“D” represents the amount of rotation of a rotational spring around the rotational axis Ry parallel to the Y-axis of the world coordinate system Σ0. “r” represents a spring constant representing the relationship between the moment m_{y} and the rotation amount D.

When the rotational axis Ry is positioned directly above the origin O of the support body 3, an intersection “H” of the rotational axis Ry and the X-Z plane of the world coordinate system Σ0 is expressed, in the world coordinate system Σ0, by Equation (19).

$$H = [ \begin{matrix}0 \\ 0 \\ h\end{matrix} ] \qquad Equation ( 19 )$$

When the rotation amount D is expressed in “radians”, the coordinate transformation matrix for transforming the world coordinate system Σ0 to the modified world coordinate system Σ1 is expressed by Equation (20) below.

$$[ \begin{matrix}cos ( D ) & 0 & sin ( D ) & - h sin ( D ) \\ 0 & 1 & 0 & 0 \\ - sin ( D ) & 0 & cos ( D ) & 0 \\ 0 & 0 & 0 & 1\end{matrix} ] \qquad Equation ( 20 )$$

According to the present embodiment, only one joint should be taken into consideration, and the robot 5 is stationary at the target position and posture. Thus, the amount of calculation necessary to obtain the modified world coordinate system Σ1 is small.

In an example, when the support body 3 is deflected by 0.05 degree after the posture of the robot 5 varies, and the tip end of a tool is assumed to be spaced from the center of rotation of deflection at a distance of 2,000 mm, the position of the tip end of the tool is displaced by approximately 1.7 mm. By contrast, if the amount of movement of the robot is corrected in accordance with the aforementioned embodiments, the displacement can be corrected to position the robot 5 at an intended position.

The robot 5 using rotary motors has been described as an example of actuators for driving links of the robot 5. However, the robot 5 may be provided with at least one direct operated motor.

According to a robot control apparatus according to the present invention, a deflection generated in a support body when a robot reaches a target position and posture is estimated, and the amount of movement of an actuator for driving the robot is calculated based on the estimated deflection of the support body. This can accurately position the robot even when the support body is elastically deformed.

Although various embodiments of the present invention have been described above, a person skilled in the art would recognize that the intended functions and effects can also be realized by other embodiments. In particular, it is possible to omit or replace a constituent element of the embodiments, or additionally provide a known means, without departing from the scope of the present invention. Further, it is obvious for a person skilled in the art that the present invention can be implemented by any combination of features of the embodiments either explicitly or implicitly disclosed herein.

1. A robot control apparatus for controlling at least one actuator for moving a plurality of links which constitute a robot fixedly installed on a support body, comprising:
a deflection estimating unit for estimating, when a tip end of the robot is assumed to reach a target position and posture, a deflection arising in the support body due to the influence of gravity acting on the robot;
a movement amount calculating unit for calculating the amount of movement of the at least one actuator which causes the tip end of the robot to reach the target position and posture, based on the deflection of the support body, which is estimated by the deflection estimating unit; and
a drive unit for driving the at least one actuator based on the amount of movement calculated by the movement amount calculating unit.

2. The robot control apparatus according to claim 1, wherein the deflection estimating unit is configured to estimate a deflection of the support body, after additionally taking the influence of acceleration of the robot into consideration.

3. The robot control apparatus according to claim 1, further comprising:
a storage unit for storing, when the support body is modeled as a rotational spring, the spring constant of the rotational spring and the position of the center of rotation of the rotational spring; and
a moment calculating unit for calculating the magnitude and direction of a moment acting on the support body under the influence of gravity acting on the robot, wherein
the deflection estimating unit is configured to estimate the deflection of the support body based on the magnitude and direction of the moment calculated by the moment calculating unit, and the spring constant and the position of the center of rotation, which are stored in the storage unit.

4. The robot control apparatus according to claim 3, wherein the moment calculating unit is configured to calculate the magnitude and direction of the moment, after additionally taking the influence of acceleration of the robot into consideration.
